(19) United States
(12) Patent Application Publication
(10) Pub. No.: US 2013/0215136 A1
(43) Pub. Date: Aug. 22, 2013

(54) LIQUID CRYSTAL DISPLAY WITH LARGE COLOR GAMUT

(71) Applicants: Meizi Jiao, Cupertino, CA (US); Jun Qi, Cupertino, CA (US); Victor Hao-En Yin, Cupertino, CA (US); Wei Chen, Palo Alto, CA (US)

(72) Inventors: Meizi Jiao, Cupertino, CA (US); Jun Qi, Cupertino, CA (US); Victor Hao-En Yin, Cupertino, CA (US); Wei Chen, Palo Alto, CA (US)

(73) Assignee: APPLE INC., Cupertino, CA (US)

(21) Appl. No.: 13/400,467

(22) Filed: Feb. 20, 2012

(51) Int. Cl. G09F 13/04; G09G 5/02; G09G 3/36; G02F 1/13357

(52) U.S. Cl. 345/590; 362/97.3; 349/62; 345/87

(57) ABSTRACT

The present disclosure relates generally to a liquid crystal display (LCD) that has a large color gamut. In certain embodiments, the large color gamut in the LCD may be obtained by adding a spectrum-filter into different layers of the LCD. The spectrum-filter may be designed to filter a portion of a color band from a light emitted from one or more light emitting diodes (LEDs) in the LED thereby increasing the color gamut on the LCD.

### BACKGROUND

The present disclosure relates generally to liquid crystal displays and, more specifically, to techniques for increasing a color gamut of liquid crystal displays.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Liquid crystal displays (LCDs) are commonly used as screens or displays for a wide variety of electronic devices, including such consumer electronics as televisions, computers, and handheld devices (e.g., cellular telephones, audio and video players, gaming systems, and so forth). Such LCD devices typically provide a flat display in a relatively thin package that is suitable for use in a variety of electronic goods.

LCDs are generally non-emissive displays that use backlights to provide light to its liquid crystals in the LCD. Some backlights use light emitting diodes (LEDs) to provide white light to the liquid crystals. Two types of white LEDs used in LCD backlights include: (1) LEDs with red and green (RG) phosphors; and (2) LEDs with Cerium-doped yttrium aluminium garnet (YAG) phosphors. LEDs with RG phosphors (i.e., RG LEDs) achieve highly saturated red and green primary colors and thus obtain a wide color gamut, but they are not as efficient or as thermally reliable as LEDs with YAG phosphors (i.e., YAG LEDs). Although YAG LEDs are indeed more efficient and thermally reliable than RG LEDs, YAG LEDs cannot obtain the same saturated red and green primary colors as the RG LEDs.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure relates generally to an LCD that has a large color gamut. YAG LEDs are commonly used in LCD backlights to produce a broad-spectrum of white light. Although YAG LEDs are stable, they are limited in achieving saturated red and green primary colors due to a high luminance of light in its yellow band (i.e., 570 nm-590 nm). In accordance with disclosed embodiments, LCDs may employ a spectrum-filter to remove some of the yellow band emitted by the YAG LEDs, thereby achieving more saturated red and green colors.

Also in accordance with disclosed embodiments, LCDs may employ a remote red phosphor in at least one of its backlight unit's layers in addition to the spectrum-filter to further enrich a red band emitted by the YAG LEDs. The remote red phosphor may help enable the LCD to obtain higher light efficiency and brightness levels.

### BRIEF DESCRIPTION OF THE DRAWINGS

Various aspects of this disclosure may be better understood upon reading the following detailed description and upon reference to the drawings in which:

FIG. 1 is a block diagram of components of an electronic device, in accordance with aspects of the present disclosure;

FIG. 2 is a front view of a handheld electronic device, in accordance with aspects of the present disclosure;

FIG. 3 is a is a view of a computer, in accordance with aspects of the present disclosure;

FIG. 4 is an exploded view of an LCD display, in accordance with aspects of the present disclosure.

FIG. 5 is a graph illustrating a change in a white LED spectrum for a YAG LED and a RG LED over wavelength, in accordance with aspects of the present disclosure.

FIG. 6 is a graph illustrating a change in a backlight spectrum for a YAG LED and a change in a corresponding LCD's red, green and blue color filter spectrums over wavelength, in accordance with aspects of the present disclosure.

FIG. 7 is block diagram of an LCD stack-up structure, in accordance with aspects of the present disclosure.

FIG. 8A is a graph illustrating a change in transmittance for a spectrum-filter used in a YAG LED backlight unit (BLU) over wavelength, in accordance with aspects of the present disclosure.

FIG. 8B is a graph illustrating a change in a backlight spectrum for a spectrum-filtered YAG LED over wavelength, in accordance with aspects of the present disclosure.

FIG. 9 is a plot illustrating a change between a color gamut of an LCD with YAG LEDs and a color gamut of an LCD with spectrum-filtered YAG LEDs, in accordance with aspects of the present disclosure.

FIG. 10A is a graph illustrating a change in a white LED spectrum for YAG LEDs from different LED bins over wavelength, in accordance with aspects of the present disclosure.

FIG. 10B is a plot illustrating a white point correction of an LCD using spectrum-filtered YAG LEDs from the different LED bins of FIG. 10A, in accordance with aspects of the present disclosure.

FIG. 11 is a plot illustrating a change between a color gamut of an LCD with YAG LEDs and a color gamut of an LCD with spectrum-filtered and LED bin-shifted YAG LEDs, in accordance with aspects of the present disclosure.

FIG. 12A is a graph illustrating change in a white LED spectrum for a YAG LED and a RG LED over wavelength, in accordance with aspects of the present disclosure.

FIG. 12B is a graph illustrating a change in a backlight spectrum for a spectrum-filtered YAG LED with a remote red phosphor over wavelength, in accordance with aspects of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure generally relates to devices and techniques for increasing saturation levels of red and green colors displayed on an LCD screen using a backlight with YAG LEDs. In general, YAG LEDs achieve limited red and green color saturations due to their high-luminance in the green-yellow band. The techniques described herein may be used to reduce the yellow band in the YAG LED spectrum, thereby widening the color gamut in the red and green directions.

According to certain embodiments, a spectrum-filter may be embedded in a backlight unit (BLU) of the LCD to filter a portion of white light emitted by the BLU in the green-yellow wavelength bands. As a result, the white LED spectrum emitted from the YAG LED resembles the white LED spectrum of the RG LED including saturated red and green colors.

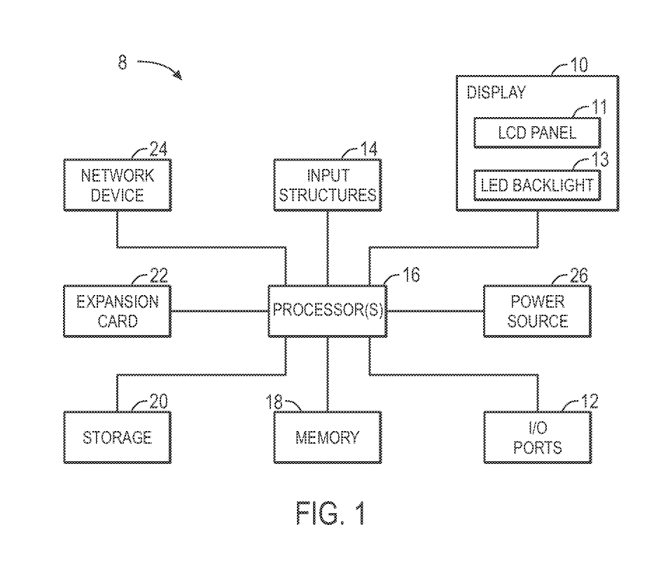

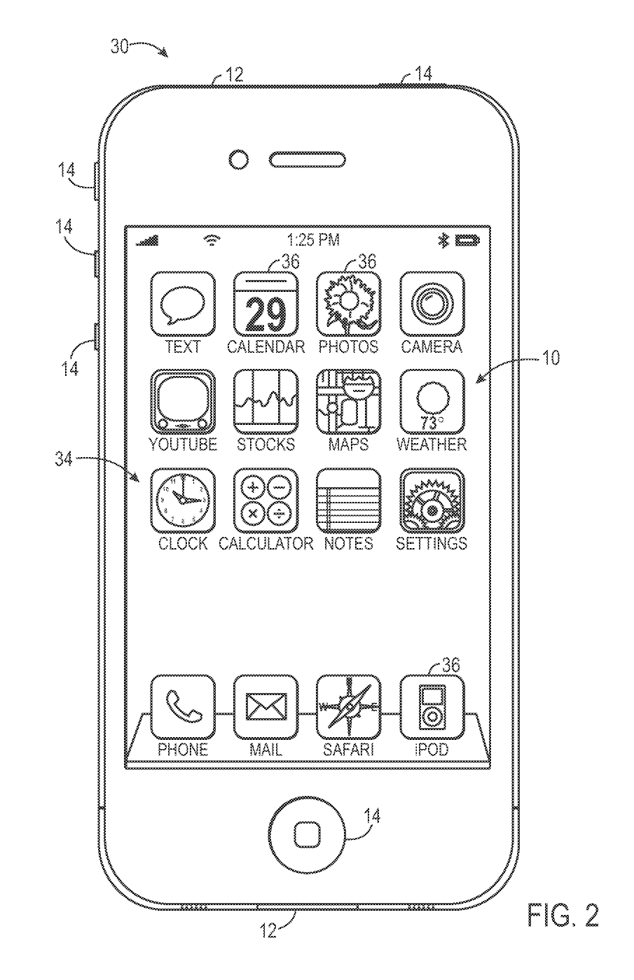

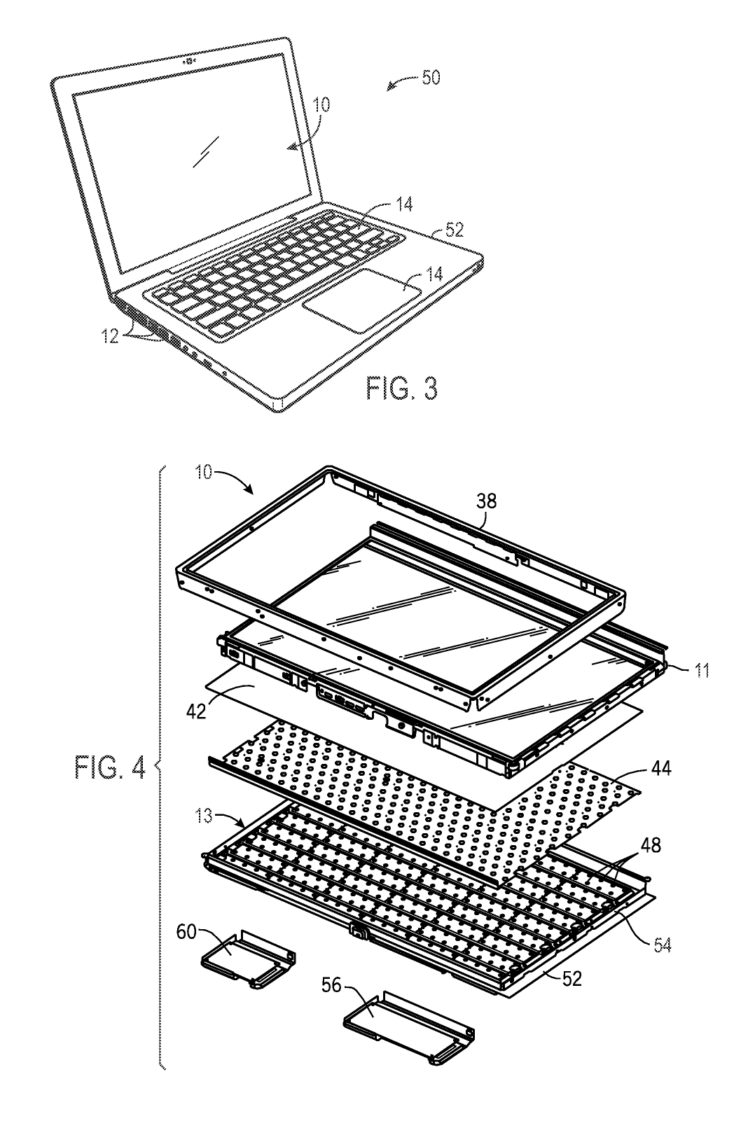

With these foregoing features in mind, a general description of suitable electronic devices using LCD displays is provided below. In FIG. 1, a block diagram depicts various components that may be present in electronic devices suitable for use with the present techniques. In FIG. 2 and FIG. 3, a handheld electronic device and a computer system are depicted as examples of suitable electronic devices that may be used with the present techniques. Although FIG. 2 and FIG. 3 depict a handheld device and a computer system as suitable electronic devices to be used with the present techniques, it should be noted that other electronic devices providing comparable display capabilities may also be used in conjunction with the present techniques.

As mentioned above, FIG. 1 is a block diagram illustrating the components that may be present in an electronic device 8 and which may allow the device 8 to function in accordance with the techniques discussed herein. It should be noted that FIG. 1 is merely one example of a particular implementation and is merely intended to illustrate the types of components that may be present in a device 8. For example, in the presently illustrated embodiment, these components may include a display 10, I/O ports 12, input structures 14, one or more processors 16, a memory device 18, a non-volatile storage 20, expansion card(s) 22, a networking device 24, and a power source 26.

With regard to each of these components, the display 10 may be used to display various images generated by the device 8 and may also be provided in conjunction with a touch-sensitive element, such as a touch screen, as part of the control interface for the device 8. The display 10 may be an LCD and may generally include LCD panel 11 and LED backlight 13 that functions as a light source for the liquid crystals in the LCD panel 11. Additional details with regard to display 10 will be described in greater detail with reference to FIG. 4 below.

The I/O ports 12 may include ports configured to connect to a variety of external devices, such as a power source, headset or headphones, or other electronic devices (such as handheld devices and/or computers, printers, projectors, external displays, modems, docking stations, and so forth). The input structures 14 may include the various devices, circuitry, and pathways by which user input or feedback is provided to the processor 16. Such input structures 14 may be configured to control a function of the device 8, applications running on the device 8, and/or any interfaces or devices connected to or used by the electronic device 8.

In certain embodiments, an input structure 14 and display 10 may be provided together, such as in the case of a touchscreen where a touch sensitive mechanism is provided in conjunction with the display 10. In such embodiments, the user may select or interact with displayed interface elements via the touch sensitive mechanism. In this way, the displayed interface may provide interactive functionality, allowing a user to navigate the displayed interface by touching the display 10.

The processor(s) 16 may provide the processing capability to execute the operating system, programs, user and application interfaces, and any other functions of the electronic device 8. The processor(s) 16 may include one or more microprocessors, such as one or more “general-purpose” microprocessors, one or more special-purpose microprocessors, graphics processing units (GPUs), and/or ASICS, or some combination of such processing components.

The instructions or data to be processed by the processor(s) 16 may be stored in a computer-readable medium, such as a memory 18. Such a memory 18 may be provided as a volatile memory, such as random access memory (RAM), and/or as a non-volatile memory, such as read-only memory (ROM). The components may further include other forms of computer-readable media, such as a non-volatile storage 20, for persistent storage of data and/or instructions. The non-volatile storage 20 may include flash memory, a hard drive, or any other optical, magnetic, and/or solid-state storage media. The non-volatile storage 20 may be used to store firmware, data files, software, wireless connection information, and any other suitable data.

The embodiment illustrated in FIG. 1 may also include one or more card or expansion slots. The card slots may be configured to receive an expansion card 22 that may be used to add functionality, such as additional memory, I/O functionality, or networking capability, to the electronic device 8.

The components depicted in FIG. 1 also include a network device 24, such as a network controller or a network interface card (NIC). In one embodiment, the network device 24 may be a wireless NIC providing wireless connectivity over any 802.11 standard or any other suitable wireless networking standard. In another embodiment, the network device 24 may be a Wi-Fi device, a radio frequency device, a cellular communication device, or the like. The network device 24 may allow the electronic device 8 to communicate over a network, such as a Local Area Network (LAN), Wide Area Network (WAN), or the Internet. Alternatively, in some embodiments, the electronic device 8 may not include a network device 24. In such an embodiment, a NIC may be added as an expansion card 22 to provide similar networking capability as described above.

Further, the components may also include a power source 26. In one embodiment, the power source 26 may be one or more batteries, such as a lithium-ion polymer battery or other type of suitable battery. Additionally, the power source 26 may include AC power, such as provided by an electrical outlet, and the electronic device 8 may be connected to the power source 26 via a power adapter.

With the foregoing in mind, FIG. 2 illustrates an electronic device 8 in the form of a handheld device 30, here a cellular telephone. It should be noted that while the depicted handheld device 30 is provided in the context of a cellular telephone, other types of handheld devices (such as media players for playing music and/or video, personal data organizers, handheld game platforms, and/or combinations of such devices) may also be suitably provided as the electronic device 8. Further, a suitable handheld device 30 may incorporate the functionality of one or more types of devices, such as a media player, a cellular phone, a gaming platform, a personal data organizer, and so forth.

For example, in the depicted embodiment, the handheld device 30 is in the form of a cellular telephone that may provide various additional functionalities (such as the ability to take pictures, record audio and/or video, listen to music, play games, and so forth). As discussed with respect to the general electronic device of FIG. 1, the handheld device 30 may allow a user to connect to and communicate through the Internet or through other networks, such as local or wide area networks. The handheld electronic device 30, may also communicate with other devices using short-range connections, such as Bluetooth and near field communication. By way of example, the handheld device 30 may be a model of an iPod®, iPad® or iPhone® available from Apple Inc. of Cupertino, Calif.

In the depicted embodiment, the enclosure includes user input structures 14 through which a user may interface with the device. Each user input structure 14 may be configured to help control a device function when actuated. For example, in a cellular telephone implementation, one or more of the input structures 14 may be configured to invoke a “home” screen or menu to be displayed, to toggle between a sleep and a wake mode, to silence a ringer for a cell phone application, to increase or decrease a volume output, and so forth.

In the depicted embodiment, the handheld device 30 includes a display 10 which may be in the form of an LCD. The display 10 may be used to display a graphical user interface (GUI) 34 that allows a user to interact with the handheld device 30. The GUI 34 may include various layers, windows, screens, templates, or other graphical elements that may be displayed in all, or a portion, of the display 10. Generally, the GUI 34 may include graphical elements that represent applications and functions of the electronic device. The graphical elements may include icons 36 and other images representing buttons, sliders, menu bars, and the like. The icons 36 may correspond to various applications of the electronic device that may open upon selection of a respective icon 36. Furthermore, selection of an icon 36 may lead to a hierarchical navigation process, such that selection of an icon 36 leads to a screen that includes one or more additional icons or other GUI elements. The icons 36 may be selected via a touch screen included in the display 10, or may be selected by a user input structure 14, such as a wheel or button.

The handheld electronic device 30 also may include various input and output (I/O) ports 12 that allow connection of the handheld device 30 to external devices. For example, one I/O port 12 may be a port that allows the transmission and reception of data or commands between the handheld electronic device 30 and another electronic device, such as a computer. Such an I/O port 12 may be a proprietary port from Apple Inc. or may be an open standard I/O port.

In addition to handheld devices 30, such as the depicted cellular telephone of FIG. 2, an electronic device 8 may also take the form of a computer or other type of electronic device. Such computers may include computers that are generally portable (such as laptop, notebook, and tablet computers) as well as computers that are generally used in one place (such as conventional desktop computers, workstations and/or servers). In certain embodiments, the electronic device 8 in the form of a computer may be a model of a MacBook®, MacBook® Pro, MacBook Air®, iMac®, Mac® mini, or Mac Pro® available from Apple Inc. By way of example, an electronic device 8 in the form of a laptop computer 50 is illustrated in FIG. 3 in accordance with one embodiment. The depicted computer 50 includes a housing 52, a display 10 (such as the depicted LCD), input structures 14, and input/output ports 12.

In one embodiment, the input structures 14 (such as a keyboard and/or touchpad) may be used to interact with the computer 50, such as to start, control, or operate a GUI or applications running on the computer 50. For example, a keyboard and/or touchpad may allow a user to navigate a user interface or application interface displayed on the display 10.

As depicted, the electronic device 8 in the form of computer 50 may also include various input and output ports 12 to allow connection of additional devices. For example, the computer 50 may include an I/O port 12, such as a USB port or other port, suitable for connecting to another electronic device, a projector, a supplemental display, and so forth. In addition, the computer 50 may include network connectivity, memory, and storage capabilities, as described with respect to FIG. 1. As a result, the computer 50 may store and execute a GUI and other applications.

With the foregoing discussion in mind, it may be appreciated that an electronic device 8, such as those in the form of either a handheld device 30 or a computer 50, may be provided with an LCD as the display 10. Such an LCD may be utilized to display the respective operating system and application interfaces running on the electronic device 8 and/or to display data, images, or other visual outputs associated with an operation of the electronic device 8.

In embodiments in which the electronic device 8 includes an LCD as display 10, the LCD may include an array or matrix of picture elements (i.e., pixels). In operation, the LCD generally operates to modulate the transmission of light through the pixels by controlling the orientation of liquid crystal disposed at each pixel. In general, the orientation of the liquid crystals is controlled by a varying an electric field associated with each respective pixel, with the liquid crystals being oriented at any given instant by the properties (strength, shape, and so forth) of the electric field.

Different types of LCDs may employ different techniques in manipulating these electrical fields and/or the liquid crystals. For example, certain LCDs employ transverse electric field modes in which the liquid crystals are oriented by applying an electrical field that is generally in-plane to a layer of the liquid crystals. Example of such techniques include in-plane switching (IPS) and fringe field switching (FFS) techniques, which differ in the electrode arrangement employed to generate the respective electrical fields.

With the foregoing in mind, and turning once again to the figures, FIG. 4 depicts an exploded view of the display 10 in the form of an LCD in accordance with aspects of the present disclosure. In particular, FIG. 4 illustrates display 10 that includes LCD panel 11 held by frame 38. Backlight diffuser sheets 42 may be located behind LCD panel 11 to illuminate the LCD panel 11 with light from LEDs 48 within LED backlight 13. LEDs 48 may include an array of white LEDs mounted on array tray 54. For example, in certain embodiments, LEDs 48 may be mounted on a Metal Core Printed Circuit Board (MCPCB), or other suitable type of support. One or more LCD controllers 56 and LED drivers 60 may be mounted beneath backlight 13. LCD controller 56 may generally govern operation of LCD panel 11, while LED drivers 60 may power and drive one or more strings of LEDs 48 mounted within backlight 13.

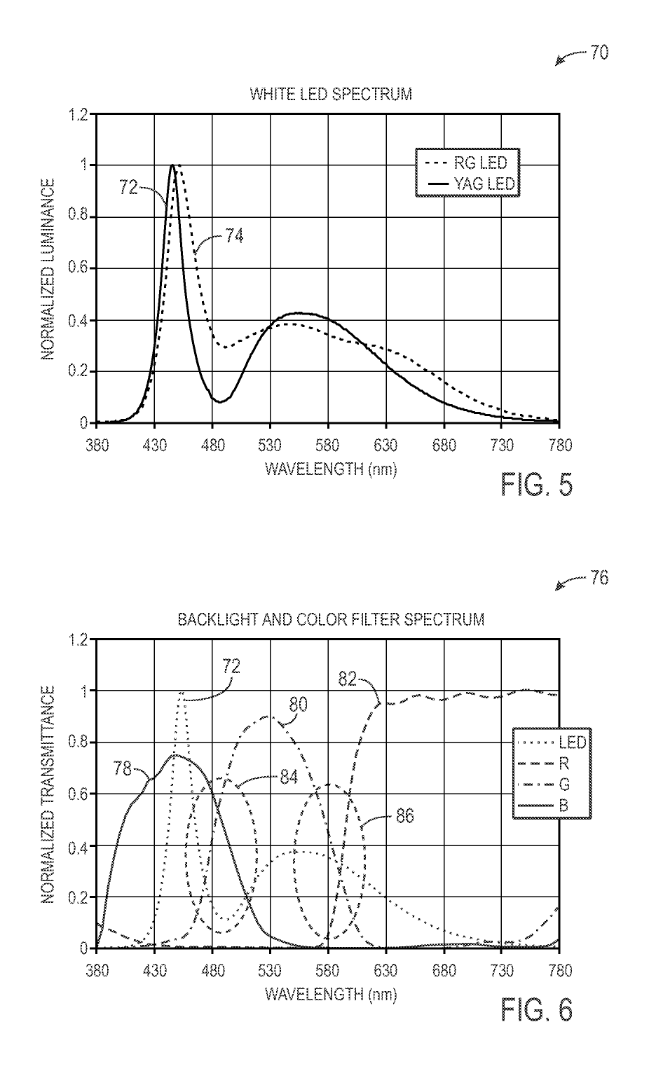

In certain embodiments, LEDs 48 may include phosphor based white LEDs, such as single color LEDs coated with a phosphor material, or other wavelength conversion material, to convert monochromatic light to broad-spectrum white light. For example, a blue LED may be coated with a yellow phosphor material to produce light that appears white. A common yellow phosphor material used for coating LEDs is Cerium doped yttrium aluminium garnet (YAG). As such, YAG LEDs are commonly used in LCD backlights. In another example, a blue LED may be coated with both a red phosphor material and a green phosphor material (i.e., RG LED). In either case, the monochromatic light, for example, from the blue LED, may excite the phosphor material to produce a complementary colored light that yields a white light upon mixing with the monochromatic light. The different spectrums of white light produced by YAG LEDs and RG LEDs are illustrated in FIG. 5.

Generally, RG LEDs can achieve saturated red and green primary colors but have reliability issues with respect to its green phosphors which can cause color change at different temperatures. Conversely, YAG LEDs are stable but limited in achieving saturated red and green primary colors due to a high luminance of light in its yellow band (i.e., 570 nm-590 nm). This high luminance of yellow band light can be seen in FIG. 5 which includes a graph 70 that illustrates a change in a white LED spectrum for a YAG LED (i.e., curve 72) and a RG LED (i.e., curve 74) over wavelength. As shown in graph 70, YAG LED curve 72 and RG LED curve 74 generally have similar luminance characteristics between 380 nm and 450 nm. However, the RG LED curve 74 has lower luminance levels than the YAG LED curve 72 between 570 nm and 590 nm (i.e., yellow band). These higher levels of luminance in the yellow band of the YAG LEDs limit the ability of the YAG LEDs to achieve saturated red and green primary colors.

In order to further describe the limited ability of the YAG LEDs in achieving saturated red and green colors, FIG. 6 illustrates a change in a backlight spectrum for a YAG LED (i.e., curve 72) and a change in a corresponding LCD's red, green and blue color filter spectrums (i.e., curve 82, 80, and 78, respectively) over wavelength in graph 76. In general, highly saturated red, green and blue colors may be achieved by limiting the overlap of the spectral peaks of the red, green and blue color filter spectrums. As shown in graph 76, although the spectral peaks of green and blue in the LCD are clearly separated, the blue-green and the yellow-red bands (i.e., 460 nm-500 nm and 560 nm-600 nm) are mixed without clear boundaries between each color (see region 84 and region 86). In order to separate the red and green spectral peaks and effectively broaden the red and green spectrums of the LCD, a spectrum-filter may be used to filter out some of the yellow light emitted by the YAG LEDs. As such, YAG LEDs may be used in a backlight capable of achieving saturated red and green colors.

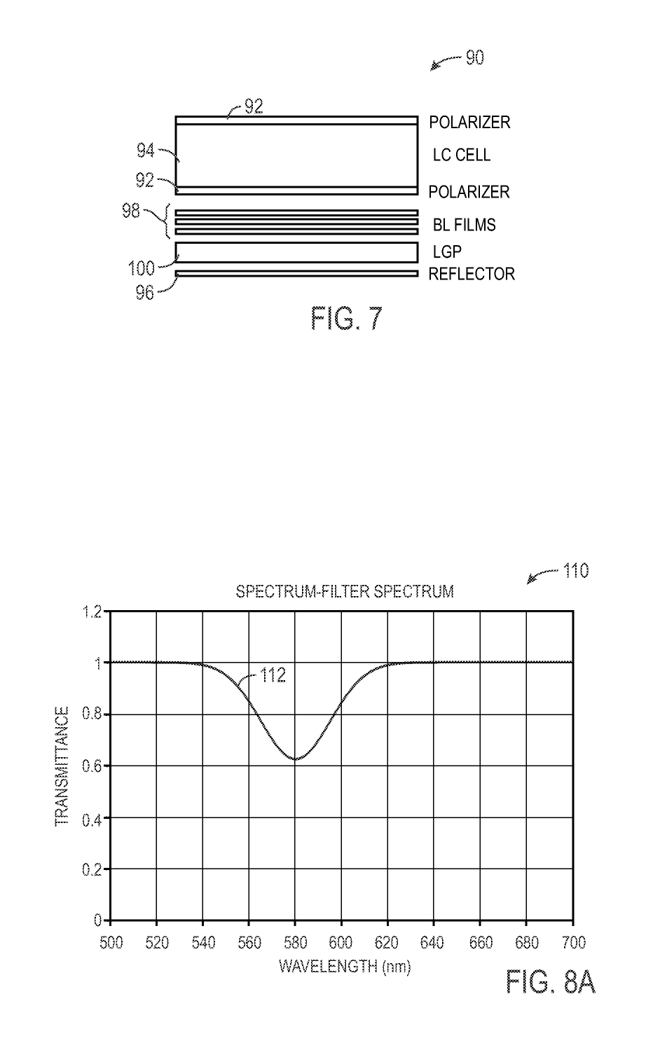

With the foregoing in mind, the spectrum-filter may be designed using dichroic filters, dye-doped filter, quantum dots and the like. In certain embodiments, the spectrum-filter may be built in different layers of LCD configuration, such as a Dual Brightness Enhancement Film (DBEF) layer, a Brightness Enhancement Film (BEF) layer, a Light Guide Plate (LGP) layer, a reflector layer or a polarizer layer of the LCD. For example, FIG. 7 illustrates a block diagram 90 of an LCD stack-up structure that includes various layers in the LCD such as polarizer layers 92, a liquid crystal (LC) layer 94, a reflector layer 96, one or more back light (BL) films layers 98, a LGP layer 100, and the like. In one embodiment, the reflector layer 96 may be an Advanced Pal Comb Filter (APCF). In this embodiment, the spectrum-filter may be built within the APCF based on thin-film interference principles, and a yellow band filter may be realized by optimizing a parameter of multi-layer films in the APCF.

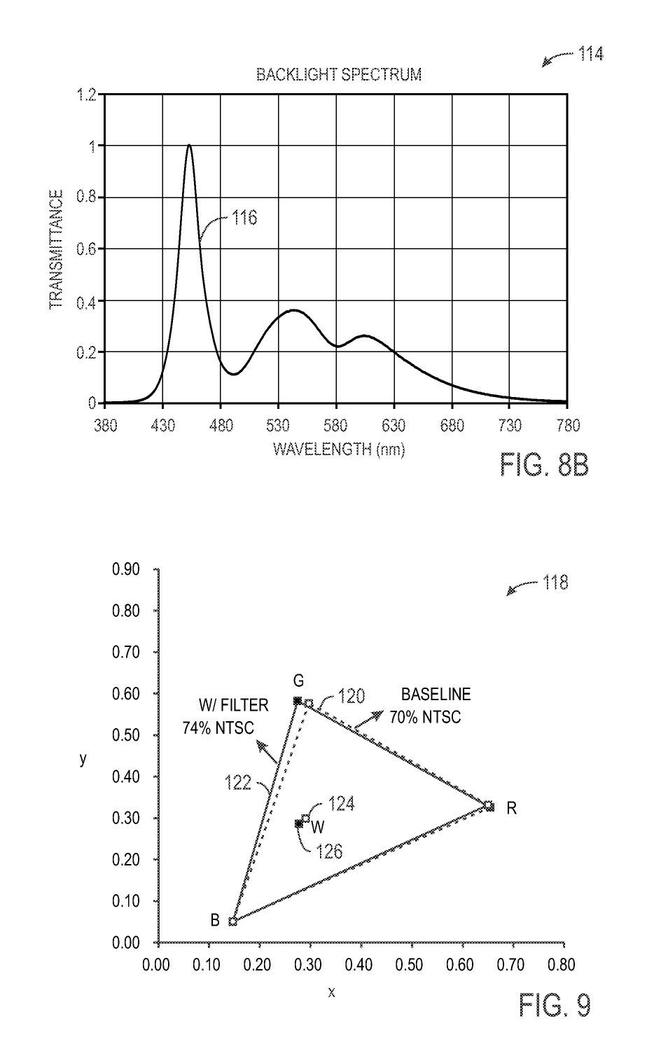

In one embodiment, the spectrum-filter may be designed to filter a portion of the yellow band emitted by YAG LEDs. For example, FIG. 8A includes a graph 110 that illustrates one example of a spectrum 112 for the spectrum-filter that may be used to filter a portion of the yellow band emitted by YAG LEDs. As shown in graph 110, the spectrum 112 has a peak absorbance or reflectance at approximately 580 nm which results in a low-transmittance band around this wavelength with a full width at half maximum (FWHM) of approximately 35 nm. The low transmittance band is assumed to follow a Gaussian shape such that the peak wavelength may be varied from 530 nm-630 nm and FWHM may be varied from 5 nm-50 nm. An example of a change in a white LED spectrum for a spectrum-filtered YAG LED is illustrated with curve 116 in graph 114 of FIG. 8B. With the foregoing in mind and referring back to FIG. 5, it can be seen that the white LED spectrum emitted by the spectrum-filtered YAG LED (i.e., spectrum-filtered YAG LED curve 116) may resemble the white LED spectrum emitted by RG LEDs (i.e., RG LED curve 74).

When comparing spectrum-filtered YAG LED curve 116 with YAG LED curve 72 in FIG. 5, it can be observed that spectrum-filtered YAG LED curve 116 has lower luminance values between 530 nm and 630 nm as compared to YAG LED curve 72. Further, with band filtering effect, the spectrum-filtered YAG LED curve 116 may be effectively broadened thereby altering the backlight spectrum produced by the spectrum-filtered YAG LED such that it more closely resembles the white LED spectrum achieved by the RG LED curve 74. Furthermore, the red, green and blue luminance peaks achieved by spectrum-filtered YAG LED curve 116 correspond to the kind of spectrum that is helpful in achieving saturated red, green, and blue colors.

Additionally, by using the spectrum-filtered YAG LED, the color gamut of the display 10 can be expanded from about 70% to about 74% of the National Television System Committee's (NTSC) color gamut. Simulated results that depict the increase in color gamut between LCDs illuminated with baseline YAG LEDs as compared to LCDs illuminated with spectrum-filtered YAG LEDs are listed below in Table 1.

TABLE 1
Color Gamut of Spectrum-filtered YAG LED

| | | | With |
|---|---|---|---|
| | | Baseline | Spectrum-Filter |
| White | x | 0.2900 | 0.2770 |
| | y | 0.2990 | 0.2865 |
| Red | x | 0.6501 | 0.6543 |
| | y | 0.3318 | 0.3260 |
| Green | x | 0.2967 | 0.2746 |
| | y | 0.5770 | 0.5827 |
| Blue | x | 0.1470 | 0.1469 |
| | y | 0.0506 | 0.0504 |

| | | |
|---|---|---|
| NTSC | 70.4% | 74.2% |
| Brightness | 100% | 90% |

The simulated results depicted in Table 1 above are further illustrated in plot 118 of FIG. 9, which illustrates the color coordinates of three primary colors for an LCD with baseline YAG LEDs (reference 120) and the color coordinates of three primary colors for an LCD with spectrum-filtered YAG LEDs (reference 122). As shown in plot 118, by using spectrum-filtered YAG LEDs, the color red is improved from (0.6501, 0.3318) to (0.6543, 0.3260), the color green from (0.2967, 0.5770) to (0.2746, 0.5827) while the color blue changes slightly from (0.1470, 0.0506) to (0.1469, 0.0504). These changes are indicative of the color gamut being widened from 70% NTSC to 74% NTSC. This widened color gamut may be attributed to a low transmittance of light in the yellow band of the spectrum-filtered YAG LED, which purifies the red and green primary colors of the YAG LEDs thereby widening the color gamut.

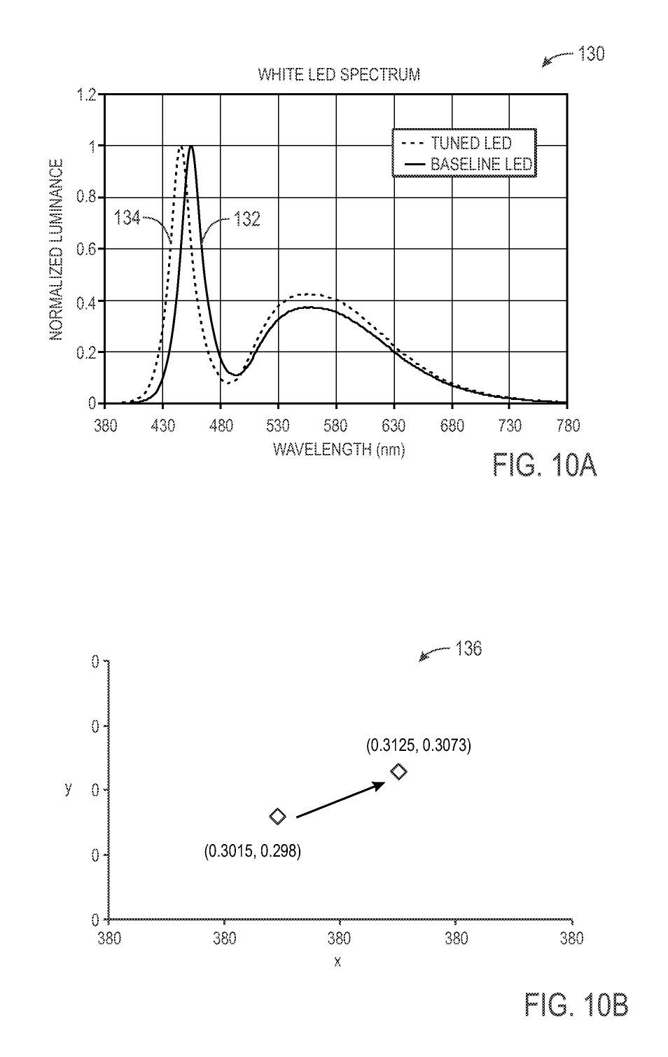

Although the use of the spectrum-filtered YAG LEDs produces a wider color gamut, side effects may include producing a lower light brightness level (˜90% of baseline YAG LEDs) and a blue shift of the spectrum-filtered YAG LEDs' white point as compared to the baseline YAG LEDs' white point. The white point shift between the baseline YAG LEDs and the spectrum-filtered YAG LEDs is illustrated with white point 124 and white point 126. In one embodiment, the spectrum-filtered YAG LEDs' white point shift may be corrected by performing a YAG LED bin shift towards yellow. That is, light produced by the YAG LEDs may be shifted towards yellow by tuning the YAG LED die and phosphor parameters to compensate for the blue shift of the spectrum-filtered YAG LEDs' white point. Based on the simulated results listed in Table 1, the spectrum-filtered YAG LEDs should be shifted towards yellow by approximately three bins in order to make the appropriate white point correction. FIG. 10A includes a graph 130 that illustrates a change in a white LED spectrum for a baseline YAG LED (i.e., curve 132) and a tuned (i.e., bin shifted) YAG LED (i.e., curve 134). Based on the change in white light spectrum between the baseline YAG LED curve 132 and the tuned YAG LED curve 134, there is approximately 4% brightness improvement by using the tuned YAG LEDs. In addition to the improvement in brightness, the tuned YAG LED achieves a white point shift towards yellow. For instance, the white point of the baseline YAG LED shifts from (0.3015, 0.298) to (0.3125, 0.3073) after using the tuned YAG LED (See plot 136 in FIG. 10B).

In one embodiment, the spectrum-filtered YAG LED may undergo a white point correction process as described above to compensate for the blue shift caused by the spectrum-filter. As a result, the brightness of the spectrum-filtered YAG LED may be increased such that the overall brightness drop between the LCD with baseline YAG LEDs and the LCD with spectrum-filtered YAG LEDs is minimized to ˜6%. Simulated results that depict the increased brightness are listed below in Table 2.

TABLE 2
Color Gamut of Spectrum-filtered & Tuned YAG LED

| | | | With |
|---|---|---|---|
| | | | Spectrum-Filter |
| | | Baseline | & Tuned |
| White | x | 0.2900 | 0.2898 |
| | y | 0.2990 | 0.2992 |
| Red | x | 0.6501 | 0.6534 |
| | y | 0.3318 | 0.3252 |
| Green | x | 0.2967 | 0.2837 |
| | y | 0.5770 | 0.6077 |
| Blue | x | 0.1470 | 0.1531 |
| | y | 0.0506 | 0.0450 |

| | | |
|---|---|---|
| NTSC | 70.4% | 77.4% |
| Brightness | 100% | 94% |

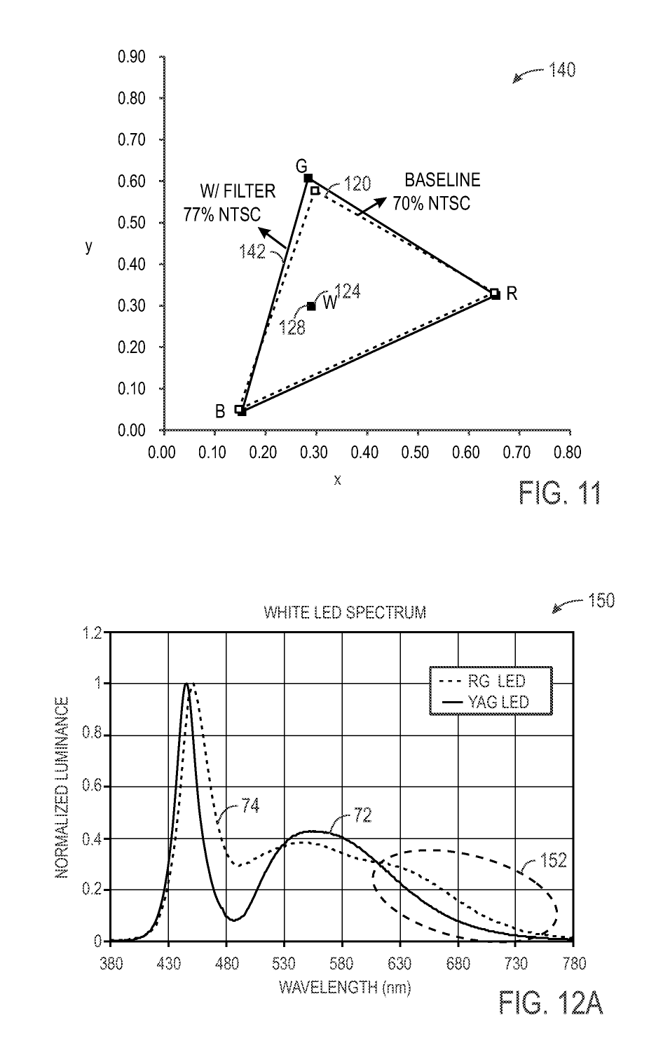

The simulated results depicted in Table 2 are further illustrated in plot 140 of FIG. 11. In particular, FIG. 11 compares the color coordinates of three primary colors for an LCD with baseline YAG LEDs (reference 120) and the color coordinates of three primary colors for an LCD with spectrum-filtered tuned YAG LEDs (reference 142). As shown in FIG. 11, the spectrum-filtered tuned YAG LED design widens the color gamut by ˜10% with red at (0.6534, 0.3252), green (0.2837, 0.6077) and blue (0.1531, 0.0450), thereby achieving more saturated red and green primary colors. In addition to having a wider color gamut, the spectrum-filtered tuned YAG LEDs maintain 94% brightness as compared to the baseline YAG LEDs.

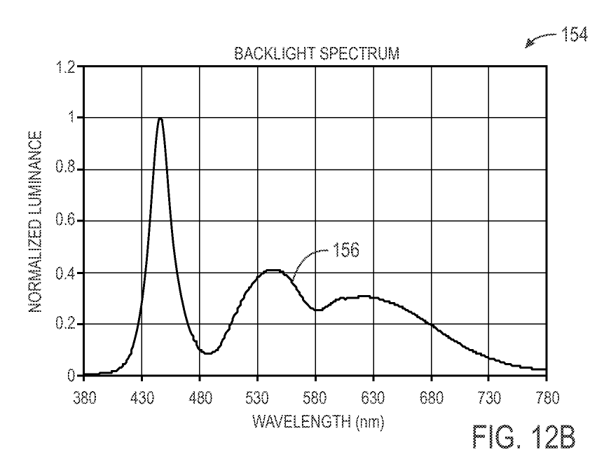

Although the spectrum-filtered YAG LED has been described as achieving more saturated red and green colors, the spectrum-filtered YAG LED has less red band as compared to the RG LED which makes it difficult to achieve the same saturated red color as the RG LED. For instance, FIG. 12A illustrates a graph 150 that depicts a change in the white LED spectrum for a baseline YAG LED (reference 72) and a RG LED (reference 74) over wavelength. Region 152 highlights the limited red band characteristics of the baseline YAG LED as compared to the RG LED.

In one embodiment, a remote red phosphor may be added in a certain layer of the LCD's backlight unit (BLU), such as diffuser sheets 42, to enrich the red band of a YAG LED. For example, a remote red phosphor added in a layer in the BLU that uses spectrum-filtered YAG LEDs may generate a backlight spectrum that emits higher levels of red band (See curve 156 in FIG. 12B). As such, the spectrum-filtered YAG LED may reduce the yellow band of the backlight spectrum, while the remote red phosphor may enrich red band of the backlight spectrum.

By using the remote red phosphor with the spectrum-filtered YAG LED, the reflected yellow light from the spectrum-filter may be recycled to excite the remote red phosphor thereby improving the light efficiency and brightness. Additionally, with more red components in the backlight spectrum, the red primary color becomes more saturated thereby further enlarging the displayed color gamut. Moreover, by using the remote red phosphor in a layer of the BLU, as opposed to mixing it with a YAG phosphor in the LEDs, the red phosphor may be controlled and binned independently. Furthermore, since the thermal sensitivity of remote phosphors is lower than other phosphors, a large variety of remote red phosphors may be used with the spectrum-filtered YAG LED.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A liquid crystal display, comprising:
a display screen having:
a plurality of liquid crystal cells; and
a backlight, comprising:
a plurality of yttrium aluminium garnet (YAG) light emitting diodes (LEDs);
a light guide configured to direct light emitted from the plurality of YAG LEDs to the display screen; and
a spectrum-filter disposed between the light guide and the display screen and configured to filter at least a portion of a yellow band from the light.

2. The liquid crystal display of claim 1, wherein the spectrum-filter comprises one or more dichroic filters, one or more dye-doped filters, or one or more quantum dots or any combination thereof.

3. The device of claim 1, wherein the spectrum-filter is disposed in one or more layers of the liquid crystal display.

4. The liquid crystal display of claim 3, wherein the layers comprise a Dual Brightness Enhancement Film (DBEF) layer, a Brightness Enhancement Film (BEF) layer, a Light Guide Plate (LGP) layer, a reflector layer, a polarizer layer, or any combination thereof.

5. The liquid crystal display of claim 4, wherein the reflector layer comprises an Advanced Pal Comb Filter (APCF) layer.

6. The liquid crystal display of claim 3, comprising a remote red phosphor in at least one of the layers of the device.

7. The liquid crystal display of claim 6, wherein the remote red phosphor is disposed in a diffuser layer.

8. The liquid crystal display of claim 6, wherein the remote red phosphor is configured to enrich a red band in the light.

9. The liquid crystal display of claim 1, wherein the plurality of YAG LEDs are configured to correct for a white point shift caused by the spectrum-filter.

10. The liquid crystal display of claim 9, wherein the YAG LEDs are selected from a bin such that a color gamut displayed on the display screen is approximately 77% or more of National Television System Committee's (NTSC) color gamut.

11. The liquid crystal display of claim 1, wherein the spectrum filter is disposed in an Advanced Pal Comb Filter (APCF), and wherein the spectrum filter is built based on thin-film interference principles and multi-layer films in the APCF.

12. The liquid crystal display of claim 1, wherein the spectrum filter comprises a low-transmittance band having a peak wavelength between about 530 nm and about 630 nm.

13. The liquid crystal display of claim 12, wherein the low-transmittance band follows a Gaussian shape.

14. An electronic device, comprising:
one or more input devices;
a memory capable of storing executable instructions;
a processor configured to receive inputs from the one or more input devices and to execute the executable instructions; and
a liquid crystal display (LCD), comprising:
a display screen having:
a plurality of liquid crystal cells; and
a backlight, comprising:
a plurality of yttrium aluminium garnet (YAG) light emitting diodes (LEDs);
a light guide configured to direct light emitted from the plurality of YAG LEDs to the display screen; and
a spectrum-filter disposed between the light guide and the display screen and configured to filter at least a portion of a yellow band from the light.

15. The electronic device of claim 14, wherein the spectrum-filter has a peak absorbance or reflectance at approximately 580 nm.

16. The electronic device of claim 14, wherein the yellow band is between about 570 nm and about 590 nm.

17. The electronic device of claim 14, wherein the spectrum-filter comprises a low-transmittance band having a full width at half maximum (FWHM) between about 5 nm and about 50 nm.

18. The electronic device of claim 14, wherein the spectrum-filter comprises a low-transmittance band having a full width at half maximum (FWHM) of approximately 35 nm.

19. The electronic device of claim 14, wherein an image produced by the LCD has approximately 74% or more of the National Television System Committee's (NTSC) color gamut.

20. A method, comprising:
emitting light from a plurality of yttrium aluminium garnet (YAG) light emitting diodes (LEDs) into a light guide;
directing the light from the light guide toward a display screen;
filtering the light from the light guide using one or more spectrum filters configured to reduce at least a portion of a yellow band in the light; and
displaying one or more images on the display screen using the filtered light.

21. The method of claim 20, wherein filtering the light comprises reducing a luminance of the light in a wavelength band between about 530 nm and about 630 nm.

22. A backlight, comprising:
a plurality of yttrium aluminium garnet (YAG) light emitting diodes (LEDs);
a light guide configured to direct light emitted from the plurality of YAG LEDs to a display screen; and
a spectrum-filter disposed proximate the light guide to filter at least a portion of a yellow band from the light.

23. The backlight of claim 22, comprising one or more diffuser sheets disposed between the light guide and the display screen, wherein the diffuser sheets comprise a remote red phosphor configured to enrich a red band of the light emitted from the plurality of YAG LEDs.

24. The backlight of claim 23, wherein the remote red phosphor is excited by a portion of the light reflected by the spectrum-filter.

25. The backlight of claim 24, wherein the portion of the light is yellow light.
